(19) United States
(12) Patent Application Publication
(10) Pub. No.: US 2006/0228806 A1
(43) Pub. Date: Oct. 12, 2006

(54) Method for detecting the modification of a characteristic of a sample caused by an enviromental influence

(75) Inventors: Rudiger Sens, Ludwigshafen (DE); Erwin Thiel, Wilnsdorf (DE); Rainer Bornemann, Gaggenau-Bad Rotenfels (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/568,584

(22) PCT Filed: Aug. 17, 2004
(86) PCT No.: PCT/EP04/09223

§ 371 Date: Feb. 17, 2006

(30) Foreign Application Priority Data
Aug. 18, 2003 (DE) 103 37 877.4

(51) Int. Cl. G01N 21/64

(52) U.S. Cl. 436/164

(57) ABSTRACT

A method detecting change of a physically measurable property of a sample due to an environmental effect, including (i) subjecting the sample to the environmental effect for an action time, the environmental effect acting on the sample with a known position-dependent intensity distribution based on a pattern function, (ii) subsequently detecting transmission, reflection, or scattering of analysis radiation by the sample as a function of position coordinates of the sample and wavelength of the analysis radiation, to determine a response function describing intensity of the transmitted, reflected, or scattered analysis radiation as a function of the position coordinates wavelength, (iii) determining correlation of the known position-dependent intensity distribution of the environmental effect, or of the pattern function on which it is based, with the response function by correlation analysis, this correlation being a measure of the change of the physically measurable property of the sample due to the environmental effect.

The invention relates to a method for detecting the change of a physically measurable property of a sample due to an environmental effect.

For the industrial production of dyestuffs, pigments, paints, UV stabilizers and sunscreen agents, it is of crucial importance to ascertain the light fastness of the products. The light fastness of a product is currently measured by exposing the product to light whose spectral distribution corresponds to that of sunlight at the earth's surface. After exposure, the color change is quantified with the aid of reference systems. Disadvantages with this procedure are the sometimes very long exposure times necessary in order to make a color change detectable for many products. According to relevant DIN standards, for instance, the exposure times are 1000 h or more. They are from 10 to 50 years for very light-fast samples. Reference is subsequently made against a color scale, for example the blue wool scale. Another disadvantage with this procedure is that the evaluation has to be carried out by a person, and this evaluation is therefore determined by a subjective impression.

Examples of samples which need particularly long exposure times are facade paints, highway signs, sealing materials for buildings, electrical insulators, roof tiles and safety glazing materials. Other samples are referred to in the following standards for exposure to light or weathering.

Relevant standards for weathering with artificial daylight are ISO 4892 (1994) for plastics, ISO 11341 (1994) for paints and coatings, ISO 11507 (1997) for coatings in devices, ISO 3917 (1999) for safety glazing materials in road vehicles, ISO 11431 (2002) for sealants in building and construction, ISO 105-B02 (1994) for textile color-fastness tests and ISO 105-B04 (1994) for the textile color-fastness weathering.

Relevant standards for direct weathering are ASTM G7, ISO 877, ISO 2810, ASTM D4141C (black box) and ASTM G24 (exposure to light under glass).

With the aim of reducing the necessary exposure time, the products are often exposed to many times the sun's intensity. It has been found, however, that the color fastnesses measured using an increased exposure intensity often do not correspond to those which are encountered under natural conditions. In other words, the color change ΔF produced in the exposed sample is dependent not only on the product of the intensity I and the exposure time Δt, which is referred to as the radiation dose S, but also explicitly on the intensity I of the radiation, i.e. ΔF=f(S, I).

It is an object of the invention to provide a measurement method with which the color change induced by light in a sample can be determined even after short exposure times, without having to use radiation exposure intensities that differ from natural conditions.

The object is achieved by a method for detecting of the change of a physically measurable property of a sample due to an environmental effect, in which

(i) the sample is subjected to the environmental effect for an action time Δt, the environmental effect being made to act on the sample with a known position-dependent intensity distribution I(x, y) (intensity pattern), which is based on a pattern function M(x, Y),

(ii) the transmission, reflection or scattering of analysis radiation by the sample is subsequently detected as a function of the position coordinates (x, y) of the sample and the wavelength λ of the analysis radiation, so as to determine a response function A(x, y, λ) which describes the intensity of the transmitted, reflected or scattered analysis radiation as a function of the position coordinates (x, y) of the sample and the wavelength λ,

(iii) the correlation of the known position-dependent intensity distribution I(x, y) of the environmental effect, or of the pattern function M(x, y) on which this is based, with the response function A(x, y, λ) is determined by correlation analysis, this correlation being a measure of the change of the physically measurable property of the sample due to the environmental effect.

In a first step (i), the substrate surface to be studied is subjected to an environmental effect. Environmental effects, in the scope of the present invention, are any external effects on the sample which are capable of changing its physically measurable properties. The environmental effect, in the scope of the present invention, include the effect of light or—more generally—radiation, mechanical forces, chemicals, gases, microorganisms, radioactive radiation, sound (for example ultrasound) and heat on the substrate surface. The environmental effect may, for example, be caused by radiation exposure or weathering of the substrate surface, or by the application of chemicals to the substrate surface. “Chemicals”, in this case, are intended to mean all substances or substance mixtures (including cosmetic formulations, for example) which can react with the substrate surface or with its constituents. The environmental effect may also involve a combination of several of the external effects mentioned as examples above. In the case of photo-oxidation, for example, light and atmospheric oxygen act together. For outside weathering tests, the weathered samples are generally subjected to the effect of light, chemicals (water, acids etc.), gases, microorganisms, heat and other mechanical effects (wind, rain).

Properties of the substrate surface are physically measurable, in the scope of the present invention, if they can be recorded via the interaction of the sample with analysis radiation shone onto the sample or into the sample. The analysis radiation may be any radiation that can interact with the sample and be transmitted, reflected or scattered by it. Examples are electromagnetic radiation, particle radiation (neutrons, radioactive alpha or beta radiation) or acoustic radiation (for example ultrasound).

The term “sample” is used very broadly and, in general, includes objects which can be deliberately subjected to particular environmental effects. For example, the sample may be a substrate coated with a pigment layer, which is subjected to UV radiation in order to study the light fastness of the pigment layer. The sample may be a field which, in order to study the efficacy of herbicides or fungicides, is treated with them and later aerially photographed. If the abrasion resistance or weatherproofness of facade coatings is intended to be studied, then the sample may be a building wall which is naturally weathered or subjected to sandblasting.

Property changes may be induced by the environmental effect, and subsequently detected, merely near the surface. It is also, however, possible for property changes in the interior of a sample to be induced by the environmental effect and subsequently detected. The latter also depends on the permeability of the sample for the environmental effect and the analysis radiation being used. Radiation may, for example, be reflected or scattered from the surface or, alternatively, fully penetrate the sample. Radiation may also be focused on a plane in the interior of the sample by suitable devices, so as to detect the property change in this plane.

In one embodiment of the present invention, the surface of a sample is studied. The term “substrate surface” will also be used below for a sample's surface which is to be studied. In this case, the term includes not only the literal geometrical surface of the sample, but also a layers of the sample which lie deeper below this geometrical surface but are still accessible to the measurement by means of the selected physical method.

An essential feature of the invention is that the environmental effect, which is capable of changing the properties of the sample, acts on the sample with a particular intensity distribution I(x, y). In other words: the action of the environmental effect on the sample, or substrate surface, is not homogeneous but has an intensity pattern. This intensity pattern may be a simple geometrical pattern, for example a strip pattern or a checkerboard pattern. The intensity pattern, however, may also be entirely irregular.

If the environmental effect acting on the sample, or substrate surface, is light with a particular wavelength or with a particular spectral distribution, then the intensity is to be equated with the radiation intensity, which is measured in W/cm². If the active environmental effect is the action of mechanical forces which, for example, are due to a substrate surface being subjected to sandblasting, then the intensity of this environmental effect may be equated with the number of sand particles striking the substrate surface per unit time and area. If the active environmental effect is the action of chemicals or gases, then the intensity of this environmental effect may be equated with the concentration of a particular substance at the position of the substrate surface. If the active environmental effect is the action of microorganisms, then the intensity of this environmental effect may be equated with the number of microorganisms per unit area.

In general, the intensity pattern has regions with a particular, essentially constant intensity, as well as regions where the intensity of the environmental effect is closed to zero or equal to zero, i.e. where essentially no action takes place on the substrate surface. These regions expediently form a simple geometrical pattern. Nevertheless, continuous intensity profiles between regions of low intensity and high intensity are also possible.

The intensity pattern of the environmental effect is preferably produced by making the environmental effect act on the sample, or substrate surface, through one or more masks, which have a specific position-dependent transmission function T(x, y) (transmission pattern), so as to produce the position-dependent intensity distribution I(x, y) as an image of the mask on the sample, or substrate surface. In this case, the pattern function M(x, y) on which the intensity pattern I(x, y) is based corresponds to the transmission function T(x, y) of the mask.

The transmission function T(x, y) describes the position-dependent permeability of the mask for the environmental effect. If the active environmental effect is light, then the mask may consist of, for example, a film which is essentially transparent for the light and which contains a printed pattern, the printed regions having a lower transmission for light of a particular wavelength, or a particular wavelength range, or being essentially nontransparent. This film may be placed on the sample in order to produce a corresponding intensity pattern on or in the sample during the exposure. If the active environmental effect is the mechanical action on a substrate surface caused by sandblasting, then the mask may be a template which has holes through which the sand jet can act on the substrate surface, but which otherwise covers the substrate surface and protects it against the action of the sandblasting. If the active environmental effect is the action of chemicals, gases or microorganisms, then the mask may likewise be a template with holes. In the case of chemicals or microorganisms, the formulations containing them may be applied to the template. The regions of a substrate surface which are covered by the template are then protected against the action of the formulations, while those in the holes of the template come into contact with the formulations. Lastly, for outside weathering tests, the regions of a substrate surface which are covered by the template are protected against all relevant environmental effects (light, chemicals, gases, microorganisms, mechanical actions). Radioactive radiation (alpha, beta radiation) can also be made to be act as a pattern on a sample by using a template which has a sufficient shielding effect.

It is, however, also possible to apply an intensity pattern to the sample, or substrate surface, without using a mask. With the action of light on a sample, for instance, the intensity distribution I(x, y) may be produced as a reference pattern on the sample. Chemicals and/or radioactive substances can also be applied to a substrate surface as a pattern (which is described by a pattern function) without using a template.

When a sample is being rain-tested, the intensity pattern may be produced by using a micro-nozzle arrangement or a rain protection grating. If the environmental effect is a thermal action on the sample, then the intensity pattern may be produced by a heating-wire arrangement. The arrangement, or grating, is described by a corresponding pattern function. Mechanical vibration patterns can be produced by standing sound waves in cavity resonators, in which case volume vibrations or surface vibrations may be excited. A sound-absorbent grating may be used for natural exposure to sound.

The sample is subjected to the environmental effect for a particular action time Δt. The action time Δt depends on the type and intensity of the environmental effect, and may last seconds, minutes, hours or days, for example from one second to 10 days.

In a second step (ii), the sample which has been subjected to the environmental effect is physically analyzed. To this end, the transmission, reflection or scattering of analysis radiation by the sample is detected as a function of the position coordinates (x, y) of the sample. The analysis radiation may have a discrete wavelength, for example a wavelength in the CO band at 5.8 μm (corresponding to 1720 cm⁻¹), or may cover a wavelength range, for example the entire visible spectral range of from 400 to 800 nm. The transmission, reflection or scattering of the analysis radiation by the sample is generally dependent on the wavelength of the analysis radiation. A response function A(x, y, λ) is thus obtained, which describes the intensity of the transmitted, reflected or scattered analysis radiation as a function of the position coordinates (x, y) of the sample and the wavelength λ. This response function may be determined for a discrete wavelength λ or for one or more wavelength ranges Δλ (for the red, green and blue ranges of visible light, for example).

The wavelength of the analysis radiation, or its spectral composition, is dictated by the sample being studied and the problem to be addressed. Analysis light in the UV-VIS and/or NIR range of the spectrum is often involved. If the light fastness of colorants is intended to be studied, i.e. the change in the color of a sample perceptible to the human eye, for example, then the analysis light will essentially have the spectral composition of daylight, or will be daylight. If the photoinduced ageing of plastics is intended to be studied by determining the CO number of the plastics, for example, then the analysis light will be NIR light with a wavelength 5.8 μm. If the stability of UV absorbers is intended to be studied, then the analysis light will comprise UVA and/or UVB light.

The measurement layout which is used is also dictated by the sample being studied and the problem. If the luster of a substrate surface, for example a paint surface, is intended to be analyzed, for instance, then it is suitable to use telecentric measuring optics for this, which substantially eliminate the effects of the scattering from deeper layers of the sample. If the light fastness of colorants is intended to be studied, however, then it is suitable to use a confocal color measurement system for this, which substantially suppresses the interfering effects of the luster.

In one embodiment of the method according to the invention, the reflection of the analysis light by a substrate surface is determined. Telecentric measurement optics are preferably used in this case. In another embodiment of the method according to the invention, the scattering of the analysis light by a substrate surface is detected. A confocal color measurement system is preferably used in this case.

The reflection or scattering of the analysis radiation by the substrate surface, as a function of the position coordinates (x, y) and the wavelength λ, may also be detected using a color scanner or a digital camera.

The detection of radioactive or acoustic radiation (ultrasound) can be carried out using with the use of imaging methods known for medical diagnosis. Thermal infrared radiation can be detected using a thermal imaging camera.

In order to make the change in the sample induced by the environmental effect more detectable, the sample may undergo further processing. A change in the hydrophilic or hydrophobic properties of the sample may, for example, be made more detectable by steaming the sample with water vapor.

The response function A(x, y, λ) is in general determined from the detected intensity values by using a digital image processing system.

If the environmental effect consists of the action of radiation which has a wavelength λᵤ, then the intensity pattern produced on or in the sample is generally also a function of the wavelength of the radiation. The pattern function M(x, y, λᵤ) on which the position- and wavelength-dependent intensity distribution I(x, y, λᵤ) is based may, for example, be the position- and wavelength-dependent transmission function T(x, y, λᵤ) of the mask used to produce the intensity pattern.

In one embodiment of the method according to the invention,

(i) the sample is subjected to the environmental effect for an action time Δt, the environmental effect being radiation and the environmental effect being made to act on the sample with a known position- and wavelength-dependent intensity distribution I(x, y, λᵤ) (intensity pattern), which is based on a pattern function M(x, y, λᵤ),

(ii) the transmission, reflection or scattering of analysis radiation by the sample is subsequently detected as a function of the position coordinates (x, y) of the sample and the wavelength λ of the analysis radiation, so as to determine a response function A(x, y, λ) which describes the intensity of the transmitted, reflected or scattered analysis radiation as a function of the position coordinates (x, y) of the sample and the wavelength λ of the analysis radiation,

(iii) the correlation of the known position- and wavelength-dependent intensity distribution I(x, y, λᵤ) of the environmental effect, or of the pattern function M(x, y, λᵤ) on which this is based, with the response function A(x, y, λ) is determined by correlation analysis, this correlation being a measure of the change of the physically measurable property of the sample due to the environmental effect.

In a third step (iii), the correlation of the known position-dependent intensity distribution I(x, y) or I(x, y, λᵤ) of the environmental effect, or of the pattern function M(x, y) or M(x, y, λᵤ) on which this is based, with the response function A(x, y, λ) determined in step (ii) is determined by correlation analysis.

Correlation analysis is a mathematical method for the recognition of characteristic patterns which is known per se. Methods of correlation analysis have been described extensively in the literature. The extent to which the (measured) response function of the sample correlates with a comparison function is studied.

A generalized correlation function is calculated for this purpose:

$$K ( α , β , {x}_{0} , {y}_{0} , λ ) = {\int }_{- ∞}^{∞} {\int }_{- ∞}^{∞} V ( α x + {x}_{0} , β y + {y}_{0} , λ ) \cdot A ( x , y , λ ) ⅆ x ⅆ y$$

α, β are freely selectable scaling parameters, x₀, y₀ are freely selectable position parameters. The above equation is to be understood as meaning that the integration is carried out over two coordinates, although it may be possibly carried out over only one coordinate. The values of V and A are set equal to 0 for variables which lie outside the measurement range.

The correlation function provides information about the extent to which the response function A(x, y, λ) is correlated with a comparison function V(αx+x₀, βy+y₀, λ), and how much this correlation changes when its variables are changed, i.e. how significant the correlation is.

The selection of the comparison function V(αx+x₀, βy+y₀, λ) is dictated by the problem to be studied. The comparison function may, but need not, be identical to the intensity distribution I(x, y, λᵤ) or to the pattern function M(x, y, λᵤ) on which it is based, or alternatively the product of the intensity distribution I(x, y, λᵤ) and the pattern function M(x, y, λᵤ). The comparison function generally describes the property change which is to be expected, or which is of interest, for the sample, or the substrate surface, due to the environmental effect. This property change, however, is expected to have the characteristic pattern of the intensity distribution of the environmental effect. The person skilled in the art will select a suitable comparison function according to the problem to be studied.

If the reflection change of a surface which takes place to following exposure to light is to be studied, for example, the comparison function should be selected so that its x-y dependency corresponds to the known x-y dependency of the known position-dependent intensity distribution I(x, y, λᵤ), or to the underlying pattern function M(x, y, λᵤ), or to the product of the intensity distribution I(x, y, λᵤ) and the pattern function M(x, y, λᵤ). The comparison function need not have any explicit wavelength dependency. But if a color change is to be studied, for example, then the comparison function will have a wavelength dependency, optionally selected while taking human perception into account.

The correlation function reflects only the intended change of the sample, i.e. that due to the environmental effect, and effectively suppresses interfering effects such as statistical noise, sample inhomogeneities and effects of extraneous light. This results in a very highly sensitivity.

Fourier analysis is a preferred variant of the general correlation analysis.

In one embodiment of the method according to the invention, the intensity distribution I(x, y, λᵤ) is a periodic intensity distribution with a spatial frequency α. A periodic intensity distribution can be generated by using a mask with a periodic transmission function T(x, y, λᵤ)=M(x, y, λᵤ). For example, it may be a so-called barcode mask, for example a transparent film with printing of regularly (equidistantly) arranged, (substantially) nontransparent bars (a so-called black-and-white barcode mask), or a template with a corresponding succession of rectangular holes. An optical grating with a corresponding pattern function M(x, y, λᵤ) may also be projected onto the sample, instead of using a mask.

A method of correlation analysis for determining the correlation between the position-dependent intensity distribution I(x, y, λᵤ) and the response function A(x, y, λᵤ) will be described below as an example. Methods of correlation analysis are known per se, and have been described extensively in the literature. The invention does not therefore consist in the provision of such mathematical methods.

If the transmission function of the mask has a periodic structure, then particularly clear situations are obtained. For example, if the transmission function
T(x,y,λᵤ)=½(1+cos(α₀x)),
is selected, and the intention is subsequently to determine the light fastness of a sample, then the following applies since V(x, y, λ)=I(x, y, λᵤ)=T(x, y, λᵤ):

$$K ( α , β , {x}_{0} , {y}_{0} , λ ) = {\int }_{- ∞}^{∞} \frac{1}{2} \cdot ( 1 + cos ( α x ) ) \cdot A ( x , y ) ⅆ x$$

The correlation function is therefore the real Fourier transform of the response function, to within a constant. α can therefore be regarded as a spatial frequency. Furthermore, K(α, β, x₀, y₀, λ) shows a contribution due to the radiation exposure only at the eigenfrequency α₀ of the mask. The correlation function vanishes at all other spatial frequencies α≠α₀. An infinitely high spatial-frequency resolving power α₀/Δα is therefore obtained.

In practice, however, it must be taken into account that the integration cannot be carried out from minus infinity to plus infinity owing to the finite sample size xₘₐₓ. Measurement furthermore does not take place out continuously, but rather the response function is digitized with a limited number of support points. The density of the support points results in an upper limit for the position frequency that can still be measured. Moreover, the finite sample size results in a finite spatial-frequency resolving power α₀/Δα, which is given by α₀/Δα=α₀·xₘₐₓ.

This means that interference due to statistical processes (signal noise) can be suppressed less effectively than when there is an infinitely high spatial-frequency resolving power. In practice, however, it has been found that the method according to the invention has a sensitivity more than one hundred-fold higher compared with visual inspection, despite these limitations.

The correlation determined in this way is a quantitative measure, independent of subjective evaluation, of the change of the physically measurable property of a sample due to the environmental effect.

The pattern recognition by means of correlation analysis results in a very high sensitivity of the detection of the changes due to the environmental effect in the sample, or on the substrate surface. This sensitivity is very much higher than in the method which is based on the visual evaluation of samples (for example with the aid of comparison samples).

In one embodiment of the method according to the invention, the intensity values of the scattered or reflected light are summed over a wavelength range Δλ and a plurality of different response functions A₁(x, y, Δλ₁), A₂(x, y, Δλ₂), A₃(x, y, Δλ₃), . . . are determined for a plurality of different wavelength ranges Δλ₁, Δλ₂, Δλ₃, . . . , and each of them is correlated with the known intensity pattern I(x, y) or I(x, y, λᵤ) of the environmental effect.

In this way, for example, it is possible to determine the extent to which the environmental effect acts on a particular property of the sample, or substrate surface, which is reflected in a change of the absorption properties of the sample, or of the substrate surface, at a particular wavelength or in a particular wavelength range, while it leaves unaffected other properties which would be reflected in the absorption properties of the sample, or substrate surface, at another wavelength or in another wavelength range.

In one embodiment of the method according to the invention, a response function is respectively determined for red, green and blue light by RGB analysis. This is done by summing the intensity values of the light reflected or scattered by the substrate surface for the red, green and blue wavelength ranges, i.e. for the wavelength ranges of for example 600-700 nm (red), 500-600 nm (green) and 400-500 nm (blue), and determining a corresponding response function for each of these wavelength ranges. Each of these response functions may subsequently be correlated with the intensity pattern I(x, y) or I(x, y, λᵤ) of the environmental effect, or the corresponding pattern functions. If the light fastness of colorants is to be studied, for example, then it is possible to determine in this way how the red, green and blue components of the light scattered by the colorant sample change after exposure (for example to sunlight) and how the color impression of the colorant is changed by this.

For example, a substrate surface may be exposed through a grating film. After exposure, the grating film is removed and the substrate surface is scanned using a scanner. The R, G, B signals of the exposed substrate surface subsequently undergo a one-dimensional Fourier transform according to the method described below. Let the intensities measured by the scanner be denoted by Sⱼ(k, m). In this case, the index j denotes the R, G, B colors (red, green and blue). Moreover, the values k and m index the position at which the intensity was measured. The direction indexed by k and m will be referred to below as an image row and as an image column, respectively. The power spectrum Pⱼ(k′, m) is calculated for each image row with the aid of the mathematical operation

$${P}_{j} ( {k}^{′} , m ) = \sqrt{\begin{matrix}{[ {\int }_{all k} {S}_{j} ( k , m ) \cdot sin ( 2 \cdot π \cdot {k}^{′} \cdot k ) \cdot ⅆ k ]}^{2} + \\ {[ {\int }_{all k} {S}_{j} ( k , m ) \cdot cos ( 2 \cdot π \cdot {k}^{′} \cdot k ) \cdot ⅆ k ]}^{2}\end{matrix}}$$

The power spectra obtained in this way for each image row are averaged over all the image columns.

$$\overline{{P}_{j} ( {k}^{′} )} = \frac{{\sum }_{all image rows} {P}_{j} ( {k}^{′} , m )}{Number of image rows}$$

The averaged power spectrum \overline{Pⱼ(k′)} is subsequently plotted against the spatial frequency k′. Photochemically induced changes in the color of the substrate surface can be identified unequivocally in the channels R, G, B since a significantly higher intensity of the averaged power spectrum can be established at the spatial frequency set by the film grating. The level of this intensity in the individual channels R, G, B is a measure of the photochemically produced color change.

For more in-depth study of the sample, the result of the described mathematical option operation is investigated more closely. Besides the power spectrum, the sign of

$${V}_{j} ( {k}^{′} , m ) = {\int }_{all k} {S}_{j} ( k , m ) \cdot cos ( 2 \cdot π \cdot {k}^{′} \cdot k ) \cdot ⅆ k$$

is now taken into account. Averaging over all the measured image rows

$${V}_{j} ( {k}^{′} ) \text{)} = \frac{{\sum }_{all image rows} {V}_{j} ( {k}^{′} , m ) \text{)}}{Number of image rows}$$

is in this case carried out for noise suppression. Vⱼ(k′) provides information about whether the environmental effect has led to an increase (Vⱼ(k′)>0) or a decrease (Vⱼ(k′)<0) of the signal measured by the scanner.

The substrate surfaces measured using the present method may be surfaces of any materials, for example the surfaces of plastics, wood, paint and paper.

It is possible to study changes of properties of the substrate materials themselves, for example of plastics, or changes of properties of substances which have been introduced into the substrate materials or applied to them, for example colorants, UV absorbers, stabilizers, cosmetic formulations.

One aspect of the present invention is the use of the present invention for studying the thermal or photoinduced ageing of plastics by spatially resulted to detection of the CO band at 5.8 μm. To this end, as described inter alia in DIN 53383, the ratio of the extinction at 5.8 μm to a particular reference extinction, which lies for example at 4.95 μm (corresponding to 2020 cm⁻¹) for the plastic polyethylene, is formed.

It is likewise possible to study the thermal or photoinduced (photo-oxidative) ageing of any other substances. Another aspect of the invention is therefore, in general, the use of the method according to the invention for studying the photoinduced or photo-oxidative ageing of substances. Examples of substances which may be studied are plastics, optionally colored using colorants, paints, metals, textiles, paper, wooden articles or construction materials.

The photoinduced ageing is detected using suitable spectroscopic bands of the substance in question. They may lie in the IR or UV-VIS ranges of the spectrum.

Another aspect of the present invention is the use of the method according to the invention for determining the color fastness of colorants. The colorants may be dyestuffs or pigments. A procedure which may be adopted in this case involves exposing a substrate surface, which contains the colorant, through a mask, preferably to sunlight or light from a solar simulator. The mask preferably has a regular transmission function with a spatial frequency, and is particularly preferably a black-and-white barcode mask with a one-dimensional spatial frequency a. The mask may be placed on the substrate surface, or fitted in front of the light source and projected onto the substrate surface using suitable optics. It is, however, also possible to produce an intensity pattern as a diffraction pattern on the substrate surface. Suitable solar simulators and light sources, which have an emission spectrum corresponding to sunlight, our known to the person skilled in the art and included, for example, xenon lamps. The sample may also be exposed to sunlight in outdoor trials, directly or indirectly by means of a system of mirrors, through a suitable weatherproof metal mask. The exposure intensity is, for example, from 20 to 2000 W/m² for UV light in the wavelength range up to 400 nm and from 500 to 5000 W/m² for light in the visible spectral range of from 400 to 800 nm, and in particular it is about 50 W/m² for UV light and therefore corresponds to the radiation intensity of natural sunlight. The exposure time (action time Δt) may be from a few seconds to several years. For very light-fast or weatherproof samples, it is generally from one week to a few months. The method according to the invention for determining the light fastness of colorants is distinguished in that even a comparatively short exposure time with a natural radiation intensity is sufficient in order to make the color change of the sample quantitatively detectable. After exposure, the mask is (optionally) removed and the substrate surface is scanned using a scanner or recorded using a digital camera. Subsequently, an RGB analysis is preferably carried out using image processing electronics, and the response functions are determined for red, green and blue light. These are subsequently correlated with the known intensity pattern of the exposure, a Fourier analysis preferably being carried out as the correlation analysis. The peak of the correlation function for red, green or blue light at the spatial frequency of the mask (or the spatial frequency of the intensity distribution I(x, y, λᵤ) corresponds quantitatively to the change, attributable to the radiation, of the red, green or blue color component in the light scattered by the substrate surface.

Another aspect of the invention is the use of the method according to the invention for determining the change of the luster of a substrate surface. Substrate surfaces which may be studied are, for example, paint surfaces, preferably those of automobile paints. For example, it is possible to study the extent to which the environmental effect leads to mechanical damage of the substrate surface, which is reflected in a change of the luster of the substrate surface. For example, cracks or pits may be formed in a paint surface. In order to detect such changes, the reflection of analysis light is measured with the aid of telecentric exposure and detection optics. The use of a telecentric measurement arrangement ensures that the sample is exposed to parallel analysis light, and that only parallel light is detected. Only changes of the luster of the sample are therefore detected, and any alterations in the color of the sample are suppressed.

Another aspect of the method according to the invention, which is not to be claimed as an invention in certain states if it is excluded from patent protection in these states, is the diagnosis of allergic skin irritations of human or animal skin due to environmental effects, for example due to cosmetic formulations or allergenic substances in general. The method according to the invention allows early detection of allergic skin irritations, long before the skin irritation has become perceptible to the eye.

Another aspect of the method according to the invention involves studying the efficacy of agricultural chemicals used in farming, such as fertilizers, fungicides, herbicides and insecticides. The substrate surface is in this case part of the earth's surface which is cultivated with economically useful crops, and the environmental effect is the introduction of chemicals into the soil or the application of chemicals to the economically useful crop. The introduction or application of the agricultural chemicals follows a particular pattern, which is described by a pattern function M(x, y). An aerial photograph of the field treated in this way is recorded (optionally at regular intervals), is digitally processing optionally and, optionally after RGB analysis, undergoes correlation analysis for the purpose of pattern recognition.

Other aspects of the invention are the use of the method according to the invention for studying the weatherproofness of substances, the chemical stability of substances or the abrasion resistance of coatings.

For example, the method according to the invention may be used in conjunction with the methods described in the relevant standards for weathering with artificial daylight or for direct weathering. Relevant standards are, for example, ISO 4892 (1994) for plastics, ISO 11341 (1994) for paints and coatings, ISO 11507 (1997) for coatings in devices, ISO 3917 (1999) for safety glazing materials in road vehicles, ISO 11431 (2002) for sealants in building and construction, ISO 105-B02 (1994) for textile color-fastness tests and ISO 105-B04 (1994) for the textile color-fastness weathering, as well as ASTM G7, ISO 877, ISO 2810, ASTM D4141C (black box) and ASTM G24 (exposure to light under glass) for direct weathering.

For instance, metal gratings may readily be used advantageously as templates in the scope of the present invention, inter alia in the following weathering and light exposure devices and boxes:

in all devices for artificial exposure or weathering which are already commercially available (see the examples);

in outdoor weathering, for example in “black boxes” (e.g. from ATLAS);

in exposure chambers for exposure to light under glass (e.g. from ATLAS);

in weathering devices with automatic tracking of the sun, for example the IP/DP box from ATLAS in Arizona and Florida;

in weathering systems with accelerated rain-testing and solar exposure using suitable mirror systems (e.g. EMMA/EMMAQUA from ATLAS).

The invention will be explained in more detail by the examples which follow.

### EXAMPLES

Radiation exposure experiments were carried out as follows in the following way:

Unless otherwise indicated, the sample area was 8×8 cm.

A grating film made of AGFA film (type 3ZESP) which had a grating structure with a period length of 1 mm, was placed on the sample and fixed using TESA film. The samples to be exposed were fixed, together with the grating film, on rigid card. The stack consisting of the film, sample and card, was additionally weighted down with a 3 mm thick sheet of quartz glass.

Except for the spruce sample (Example 1), all the sample stacks were exposed to light under outdoor conditions in a commercial suntester from ATLAS (SUNTEST XLS Plus).

The grating films were removed after exposure. The exposed samples were placed with the exposed side downward on the object glass of a scanner (HP SCAN-JET 550 C) and scanned under the following conditions:

True Color (16.7 million colors)

Resolution: 1200 dpi

Contrast: medium

Color: automatic

Exposure: automatic

The grating film was also scanned.

The R, G, B signals of the exposed sample surfaces areas subsequently underwent a one-dimensional Fourier transform using the method described below. Let the intensities measured by the scanner be denoted by Sⱼ(k, m). In this case, the index j denotes the R, G, B colors (red, green and blue). Moreover, the values k and m index the position at which the intensity was measured. The direction indexed by k and m will be referred to below as an image row and as an image column, respectively. The power spectrum Pⱼ(k′, m) was calculated for each image row with the aid of the mathematical operation

$${P}_{j} ( {k}^{′} , m ) = \sqrt{\begin{matrix}{[ {\int }_{all k} {S}_{j} ( k , m ) \cdot sin ( 2 \cdot π \cdot {k}^{′} \cdot k ) \cdot ⅆ k ]}^{2} + \\ {[ {\int }_{all k} {S}_{j} ( k , m ) \cdot cos ( 2 \cdot π \cdot {k}^{′} \cdot k ) \cdot ⅆ k ]}^{2}\end{matrix}}$$

The power spectra obtained in this way for each image row were averaged over all the image columns.

$$\overline{{P}_{j} ( {k}^{′} )} = \frac{{\sum }_{all image rows} {P}_{j} ( {k}^{′} , m )}{Number of image rows}$$

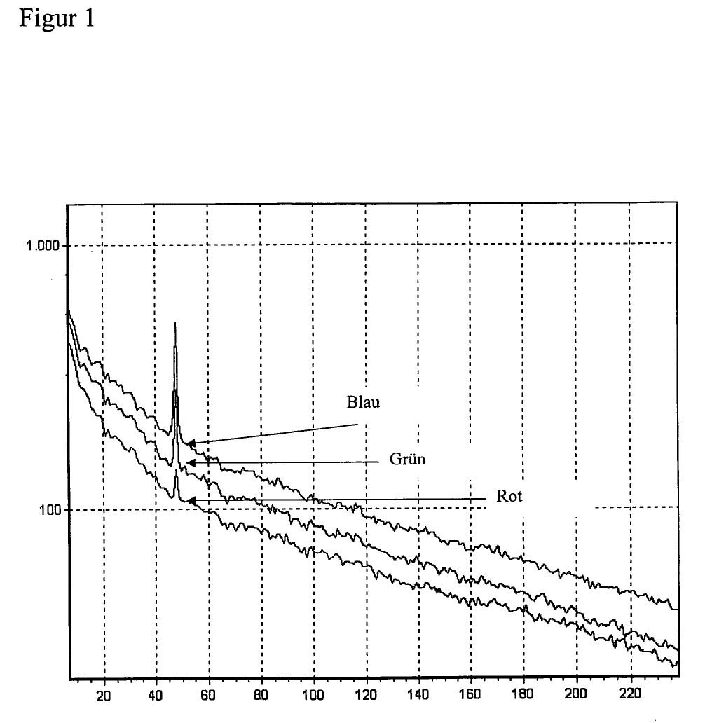

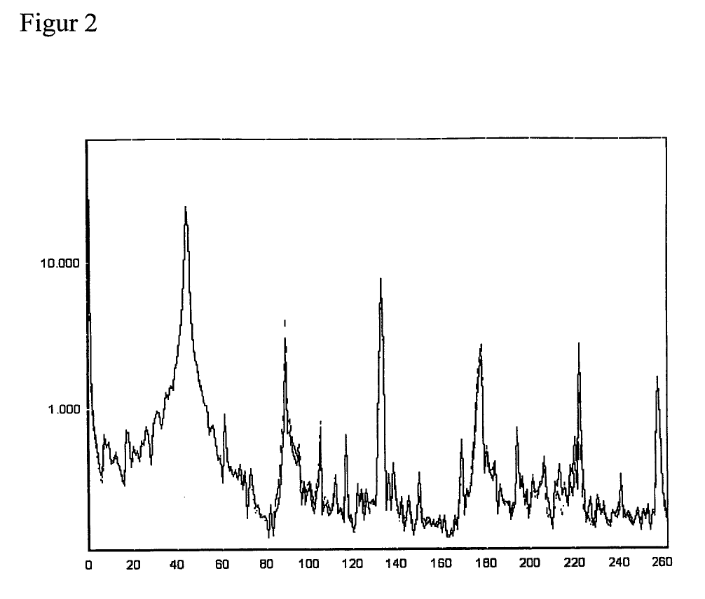

In FIGS. 1, 2, 4 and 6, the averaged power spectrum \overline{Pⱼ(k′)} is respectively plotted against the spatial frequency k′. Photochemically induced color changes can be identified unequivocally in the channels R, G, B since a significantly higher intensity of the averaged power spectrum can be established at the spatial frequency set by the film grating. The level of this intensity in the individual channels R, G, B is a measure of the photochemically produced color change. The values plotted on the x axis and the y axis in the figures are respectively proportional to the spatial frequency and the intensity of the averaged power spectrum.

### Example 1

A light spruce panel with a size of 15×10 cm was exposed to sunlight for 15 minutes under outdoor conditions through the grating sheet with the spatial frequency 1/mm.

After exposure, the film grating was removed and the wood surface was visually assessed. No change of the sample surface could be seen with the eye. In particular, no grating pattern was perceptible to the eye.

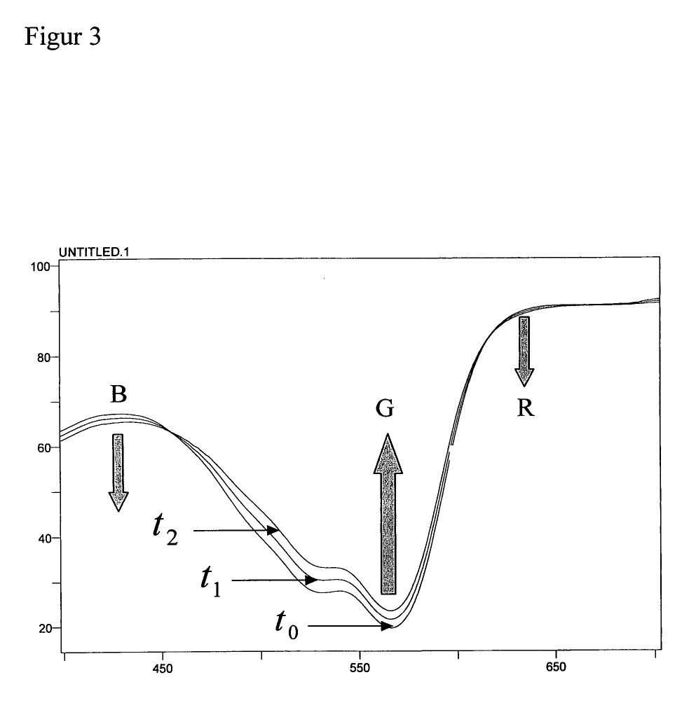

The result of the one-dimensional Fourier transform is represented in FIG. 1 for the exposed spruce panel and in FIG. 2 for the grating film.

At the grating's spatial frequency of 43 which can be seen in FIG. 2, FIG. 1 shows Fourier signal peaks which are respectively very high in the blue channel, moderate in the green channel and relatively small in the red channel. This corresponds to browning of the wood surface, but far below a level which would be visible.

The signal amplitudes are plotted logarithmically in order to make it easier to see small effects such as noise etc. The obtained Fourier signal peaks are therefore very high in absolute terms.

### Example 2

a) Conventional Exposure (Comparison)

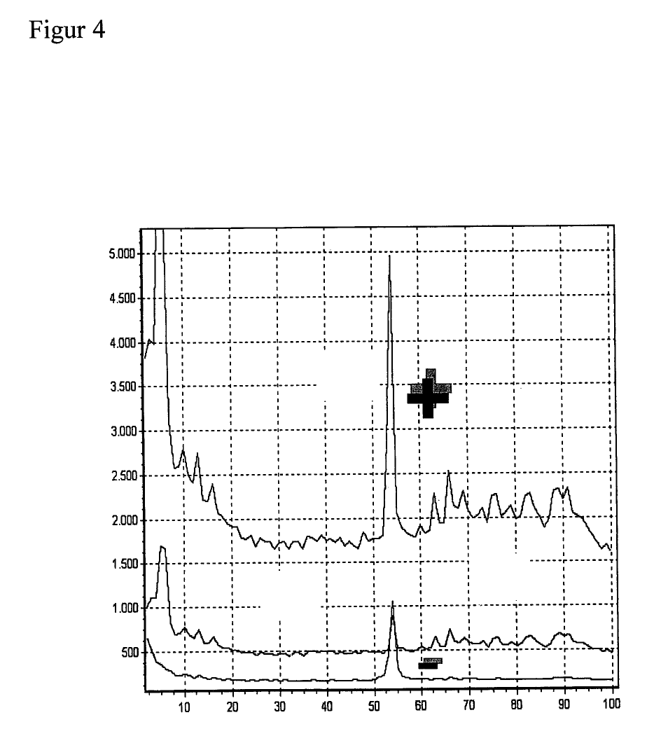

Magenta ink was printed surface-wide onto an overhead projector film using an inkjet printer of the HP 2000 C type. This ink was exposed under outdoor conditions in the ATLAS XLS Plus suntester for one day. The film was studied by transmission spectroscopy before the start of the exposure (time t₀) and after exposure times of 8 hours (time t₁) and 24 hours (time t₂). The results are represented in FIG. 3. In this case, the transmission in % (y axis) is plotted against the wavelength in nm (x axis).

As can be seen from the transmission spectra at the times t₀, t₁ and t₂, the transmission increases significantly in the green spectral range during the exposure. In the blue and red spectral ranges, however, a (slight) decrease of the transmission is observed.

Overall, brightening takes place which is even perceptible to the eye, and which is typically evaluated coloristically.

b) Grating Exposure (According to the Invention)

A magenta film identical to the film used in a) was exposed to artificial sunlight through the grating film described above. The exposure time was only 10 minutes!

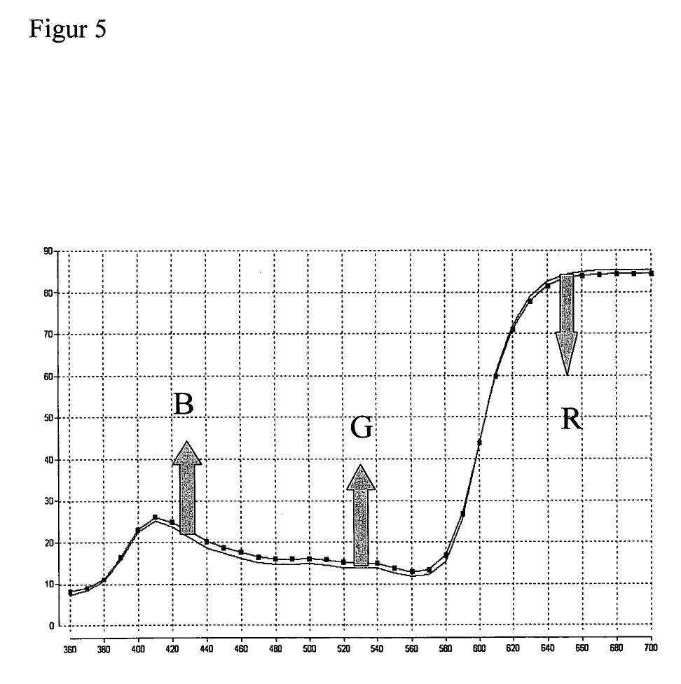

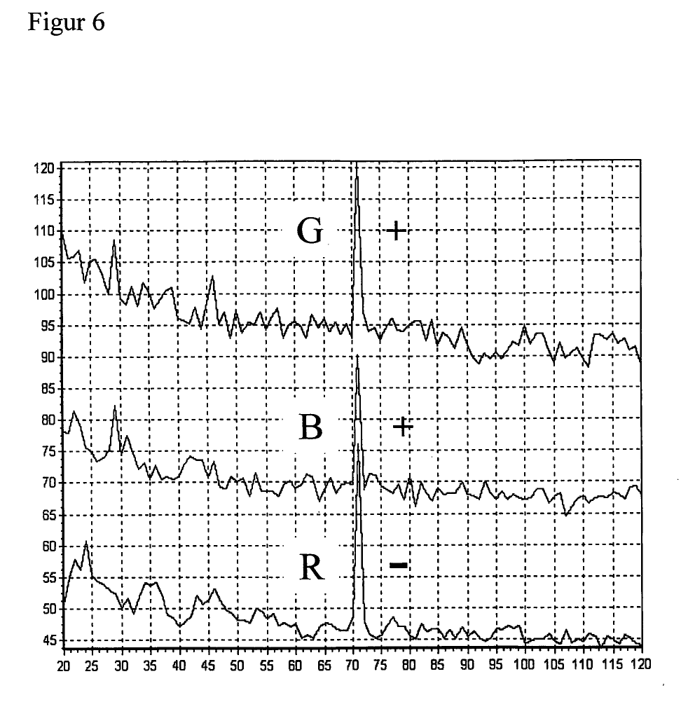

The result of the one-dimensional Fourier analysis of the scanned image of the exposed film is represented in FIG. 4.

At the spatial frequency of the grating film, a large signal peak is observed in the green channel (upper curve), a small signal peak in the blue channel (lower curve) and an even smaller signal peak in the red channel (middle curve).

A time acceleration factor of about 100, which is achieved by the method according to the invention, can be estimated in the present example by comparing the experiments in 2a and 2b.

### Example 3

a) Conventional Exposure (Comparison)

A test paint from BASF AG, Ludwigshafen, DE with a P.R. 178 brightener was conventionally exposed as described above under outdoor conditions for 600 hours.

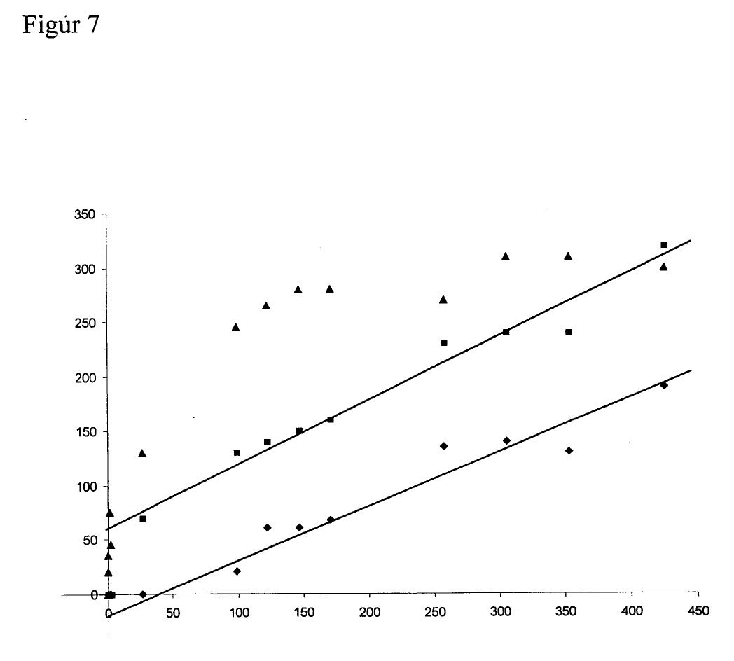

The paint sample was characterised by reflection spectroscopy before and after exposure. The results are presented in FIG. 5. The dotted line corresponds to the exposed sample, and the solid line corresponds to the unexposed sample. In this case, the reflectivity in % (y axis) is plotted against the wavelength (x axis).

After exposure, as can be seen in FIG. 5, the reflectivity of the paint sample increases by a few percent in the blue and green spectral ranges and decreases by a few percent in the red spectral range. This leads to a slight cloudiness, barely perceptible to the eye, and simultaneous brightening of the paint sample.

b) Grating Exposure (According to the Invention)

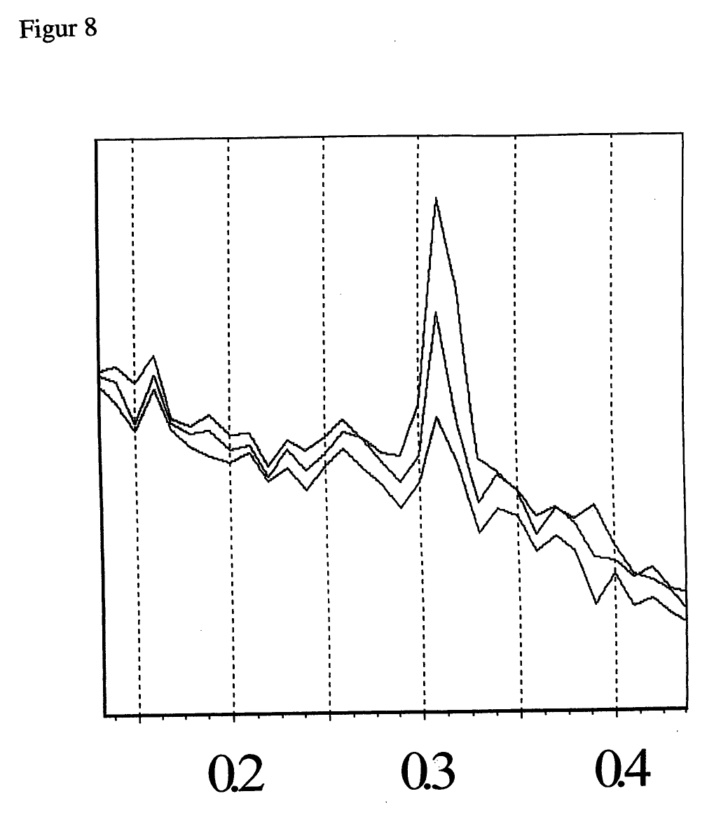

The paint sample was exposed through the grating film described above under outdoor conditions. The exposure time was only 92 hours. FIG. 6 presents the result of the one-dimensional Fourier analysis of the scanned image of the exposed paint sample.

At the grating film's spatial frequency of 71, signal peaks with an approximately equal amplitude, which are about five times higher than the noise level, can be seen in all three color channels. They represent the change of the reflectivity in the red, green and blue spectral ranges. The very clear measurement signal was already obtained after an exposure time of only 92 hours.

### Example 4

A test paint from BASF AG, Ludwigshafen, DE with a P.R. 122 brightener underwent weathering in a commercial weathering device (W.O.M CI 35A from ATLAS) according to the SAE 1960, CAM 180 test method. The weathering pattern was produced with the aid of a metal grating with an area of 5 cm×7 cm, which had 3 mm wide bars spaced 3 mm apart (corresponding to a spatial frequency of 0.166/mm). The grating was positioned 3 mm in front of the sample surface by means of a suitable retaining device.

After particular time intervals, the retaining device with the sample was taken out of the weathering device. The metal grating in front of the sample surface was removed and the sample surface was, as generally described above, scanned and evaluated by means of RGB analysis and a one-dimensional FT transform. The amplitude of the FT signal peak for the channels R, G and B was determined after each time interval. Finally, the metal grating was put back into the frame in the same position, and the weathering was continued.

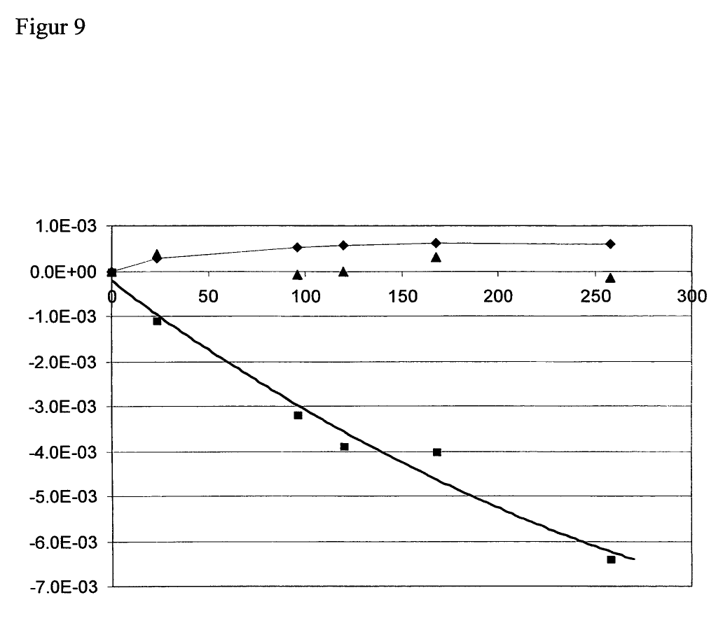

The amplitude of the FT signal peak is plotted against the weathering time for the channels R (triangles), G (rhombi) and B (squares) in FIG. 7. As can be seen from the figure, an approximately linear rise of the FT signal peak with time can be observed in the blue and green channels. In the red channel, however, a steep rise of the FT signal peak is very soon observed, but it remains approximately constant after about 300 weathering hours.

The grating weathering is therefore outstandingly suitable both for the characterization of specific product properties and for the prediction of color changes during longer exposure times, by extrapolating the signal amplitudes in the individual color channels. It could also be determined that the FT signal peaks in the red and blue channels have a negative sign, which indicates a decreases of the reflectivity for red and blue analysis radiation due to absorbent photoproducts, while the FT signal peak has a positive sign in the green spectral range, which indicates an increase of the reflectivity for green analysis light due to photochemical degradation of P.R. 122.

No color change of the paint sample can be seen visually even after a weathering time of 420 hours. In the case of the higher weatherproof pigment P.R. 122, a weathering time of at least 1000 weathering hours is necessary in order for a color shade change to be clearly perceptible to the eye.

1-38. (canceled)

39. A method for detecting change of a physically measurable property of a sample due to an environmental effect, comprising:
(i) subjecting the sample to the environmental effect for an action time, the environmental effect being made to act on the sample with a known position-dependent intensity distribution, which is based on a pattern function;
(ii) subsequently detecting transmission, reflection, or scattering of analysis radiation by the sample as a function of position coordinates of the sample and wavelength of the analysis radiation, so as to determine a response function that describes intensity of the transmitted, reflected, or scattered analysis radiation as a function of the position coordinates of the sample and the wavelength; and
(iii) determining correlation of the known position-dependent intensity distribution of the environmental effect, or of the pattern function on which this is based, with the response function by correlation analysis, the correlation being a measure of the change of the physically measurable property of the sample due to the environmental effect.

40. The method as claimed in claim 39, wherein the environmental effect is made to act on the sample through a mask, which has a specific position-dependent transmission function, so as to produce the position-dependent intensity distribution as an image of the mask on the sample.

41. The method as claimed in claim 39, wherein the environmental effect includes action of radiation, and the intensity distribution is a position-dependent and wavelength-dependent intensity distribution.

42. The method as claimed in claim 39, wherein the environmental effect includes action of light.

43. The method as claimed in claim 39, wherein the environmental effect includes action of mechanical forces.

44. The method as claimed in claim 39, wherein the environmental effect action of chemicals.

45. The method as claimed in claim 39, wherein the environmental effect includes action of gases.

46. The method as claimed in claim 39, wherein the environmental effect includes action of microorganisms.

47. The method as claimed in claim 39, wherein the environmental effect includes action of radioactive radiation.

48. The method as claimed in claim 39, wherein the environmental effect includes action of sound waves.

49. The method as claimed in claim 39, wherein the environmental effect includes action of heat.

50. The method as claimed in claim 39, wherein the environmental effect is caused by weathering of the sample.

51. The method as claimed in claim 39, wherein the environmental effect is caused by application of chemicals to the sample.

52. The method as claimed in claim 41, wherein the intensity distribution is produced as a reference pattern on the sample.

53. The method as claimed in claim 41, wherein the intensity distribution is produced by exposing the sample to light through the mask, which has a position-dependent and wavelength-dependent transmission function.

54. The method as claimed in claim 53, wherein exposure is carried out with artificial or natural sunlight.

55. The method as claimed in claim 53, wherein the mask is a barcode mask.

56. The method as claimed in claim 39, wherein the intensity distribution is a periodic intensity distribution with a spatial frequency.

57. The method as claimed in claim 50, wherein the correlation analysis is a Fourier analysis.

58. The method as claimed in claim 39, wherein the transmission, reflection, or scattering of analysis light in UV-VIS and/or NIR ranges is determined.

59. The method as claimed in claim 39, wherein the transmission, reflection, or scattering of analysis radiation by the sample is determined for a plurality of wavelength ranges, so as to determine a plurality of response functions for the plurality of wavelength ranges.

60. The method as claimed in claim 59, wherein a response function is respectively determined for red, green and blue light by RGB analysis.

61. The method as claimed in claim 39, wherein the reflection of the analysis light is detected.

62. The method as claimed in claim 61, wherein telecentric measurement optics are used for detection of the reflection.

63. The method as claimed in claim 39, wherein the scattering of the analysis light is detected.

64. The method as claimed in claim 63, wherein a confocal color measurement system is used for detection of the scattering.

65. The method as claimed in claim 39, wherein the reflection or scattering of the analysis light by the sample as a function of the position coordinates is detected using a color scanner.

66. The method as claimed in claim 39, wherein the reflection or scattering of the analysis light by the sample as a function of the position coordinates is detected using a digital camera.

67. The method as claimed in claim 39, wherein the response function is determined using a digital image processing electronics.

68. The method as claimed in claim 61 for determining the change of luster of a substrate surface.

69. The method as claimed in claim 68, wherein the substrate surface is a paint surface.

70. The method as claimed in claim 69, wherein the paint is an automobile paint.

71. The method as claimed in claim 63 for determining light fastness of colorants, or of substrates colored using the colorants.

72. The method as claimed in claim 39 for studying photoinduced or photo-oxidative aging of substances.

73. The method as claimed in claim 72, wherein the substances are selected from plastics, optionally colored using colorants, paints, textiles, metals, paper, wooden articles, construction materials, and cosmetic formulations.

74. The method as claimed in claim 39 for studying weatherproofness of substances.

75. The method as claimed in claim 39 for studying chemical stability of substances.

76. The method as claimed in claim 39 for studying abrasion resistance of coatings on a substrate.
